(19) United States
(12) Patent Application Publication
(10) Pub. No.: US 2009/0081903 A1
(43) Pub. Date: Mar. 26, 2009

(54) Electrical connector

(75) Inventors: Guo-Hui Zhang, Kunshan (CN); Zhi-Gang He, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/284,363

(22) Filed: Sep. 22, 2008

(30) Foreign Application Priority Data
Sep. 22, 2007 (CN) 200720044129.8

(51) Int. Cl. H01R 24/00

(52) U.S. Cl. 439/626

(57) ABSTRACT

An electrical connector comprises an insulating housing of one piece and a plurality of contacts retained in the passageways. Said insulating housing comprises an engaging portion, a supporting portion and a plurality of passageways along a longitudinal direction of the insulating housing, said engaging portion and said supporting portion respectively define a mating surface and a supporting surface. Each contact comprises a base portion retained in the passageway, a male mating arm and a female mating arm respectively extend upwardly from said base portion. Said female mating arm has a spring leg extending apart from said male mating arm, said spring leg has a mating portion at a free tip end thereof curlily extending toward said male mating arm, said male mating arm projects upwards beyond the supporting surface of the supporting portion. The electrical connector mates with an identical connector, both of which can share with a same mold during the process of manufacturing to save the cost.

### BACKGROUND OF THE INVENTION

1. Field of the Invention

The present invention relates to an electrical connector, and more particularly to an electrical connector for connecting two PCBs (printed circuit board) electrically.

2. Description of Related Art

Nowadays, a board-to-board electrical connector assembly is widely used in an electronic device for connecting two PCBs electrically. U.S. Pat. No. 5,498,167 discloses an electrical connector assembly comprising a plug and a receptacle mating with said plug. Said plug having an identical structure with said receptacle includes a first housing and a plurality of first contacts retained on two sides of said first housing. Said first contacts consist of a plurality of male contacts and a plurality of female contacts corresponding to said male contacts. Each female contact has a pair of spring contacting arms. Said receptacle includes a second housing and a plurality of second contacts consisting of a plurality of male contacts and female contacts, which share a same structure with said first housing and first contacts respectively to reduce the cost of manufacture. Thus, said plug and said receptacle can share a same mold during the process of manufacture. Said male contacts of the first contacts mate with said female contacts of the second contacts during the plug mates with the receptacle. Said male contact of the receptacle has a mating arm mating with said spring contacting arms of said female contact of the plug. Said male contacts and female contacts are formed in different structures, so it is necessary to develop two different molds respectively during the process of manufacture, which improves the cost. Moreover, said male contacts and female contacts of the plug are retained on two sides of the housing defining a space therebetween, so the size of the housing is large so as to retain said male contacts and female contacts, which fails to meet the trend of development of said electrical connector.

So it is necessary to provide a new electrical connector to solve the problems above.

### SUMMARY OF THE INVENTION

Accordingly, it is an object of the present invention to provide an electrical connector which can reduce size and the cost of manufacturing.

In order to achieve above-mentioned object, an electrical comprises an insulating housing of one piece comprising an engaging portion, a supporting portion and a plurality of passageways along a longitudinal direction of the insulating housing, said engaging portion and said supporting portion respectively define a mating surface and a supporting surface; a plurality of contacts retained in the passageways, each contact comprises a base portion retained in the passageway, a male mating arm and a female mating arm respectively extend upwardly from said base portion; wherein said female mating arm has a spring leg extending apart from said male mating arm, said spring leg has a mating portion at a free tip end thereof curlily extending toward said male mating arm, said male mating arm projects upwards beyond the supporting surface of the supporting portion.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of the electrical connector in accordance with the present invention;

FIG. 2 is an exploded perspective view of the electrical connector of FIG. 1;

FIG. 3 is an exploded perspective view of the electrical connector of FIG. 2 from another view;

FIG. 4 is a cross-section view of the electrical connector and an identical counter connector before mating with each other; and

FIG. 5 is a cross-section view of the electrical connector and an identical counter connector after mating with each other.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

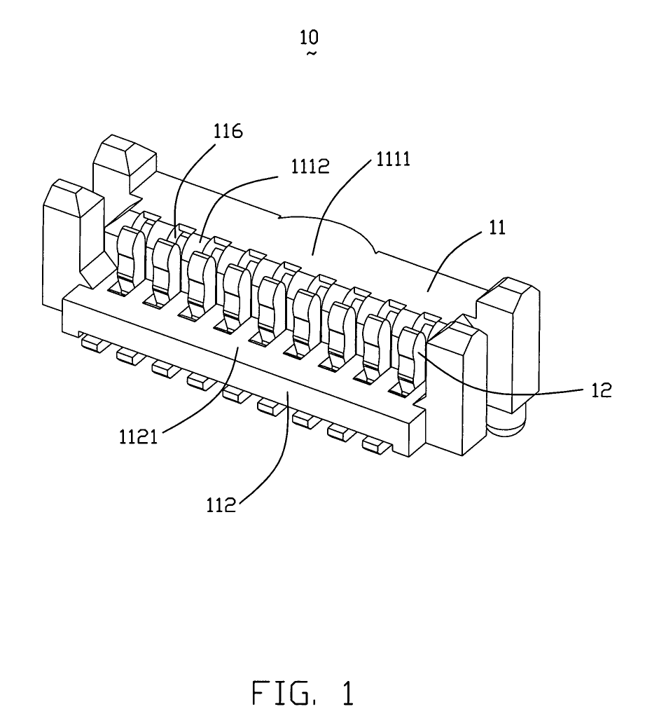

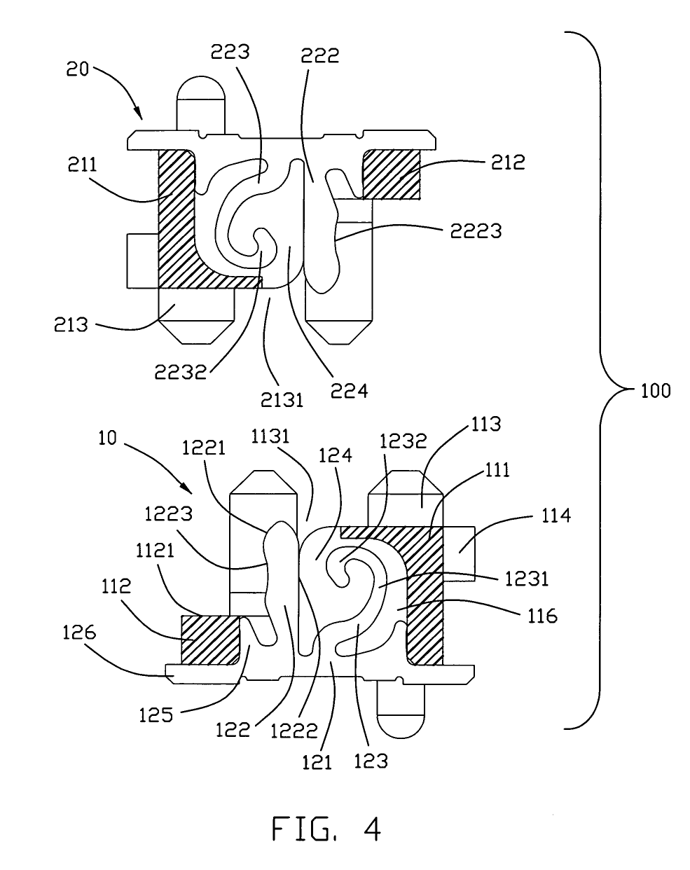

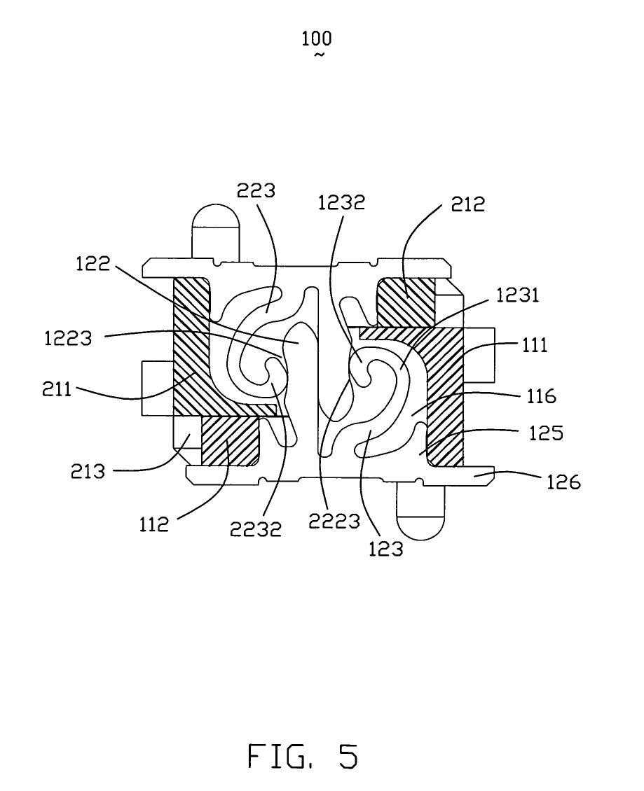

Referring to FIGS. 4 to 5, an electrical connector 10 in accordance with the present invention is provided for mating with an identical counter connector designated as 20, which has a same structure with the electrical connector 10 for connecting two PCBs electrically. The electrical connector 10 as shown in FIG. 1, 2 and 3 comprises an insulating housing 11 and a plurality of contacts 12 received into a plurality of passageways 116 formed on said insulating housing 11.

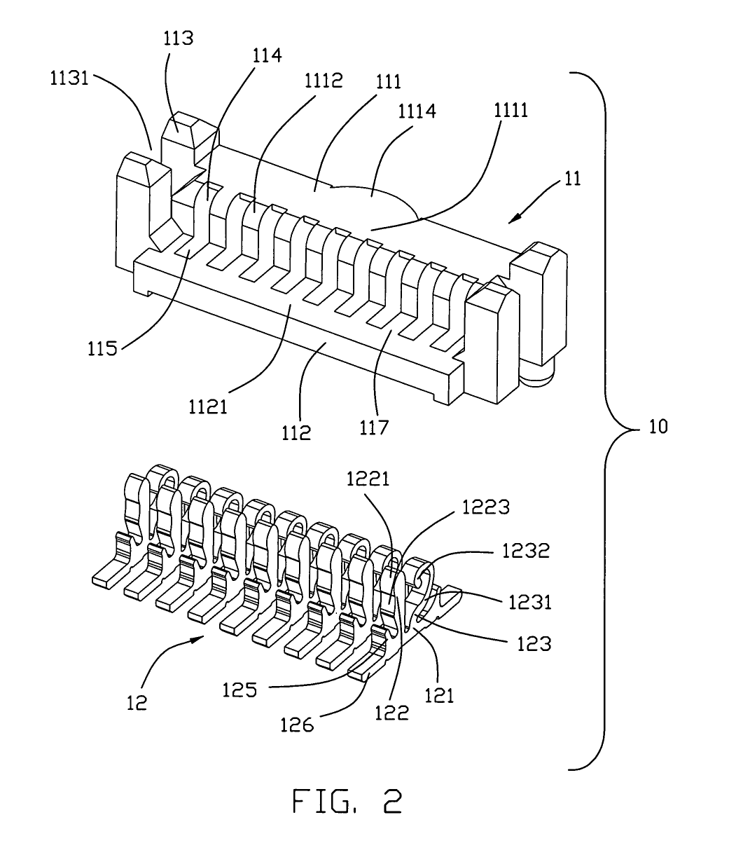

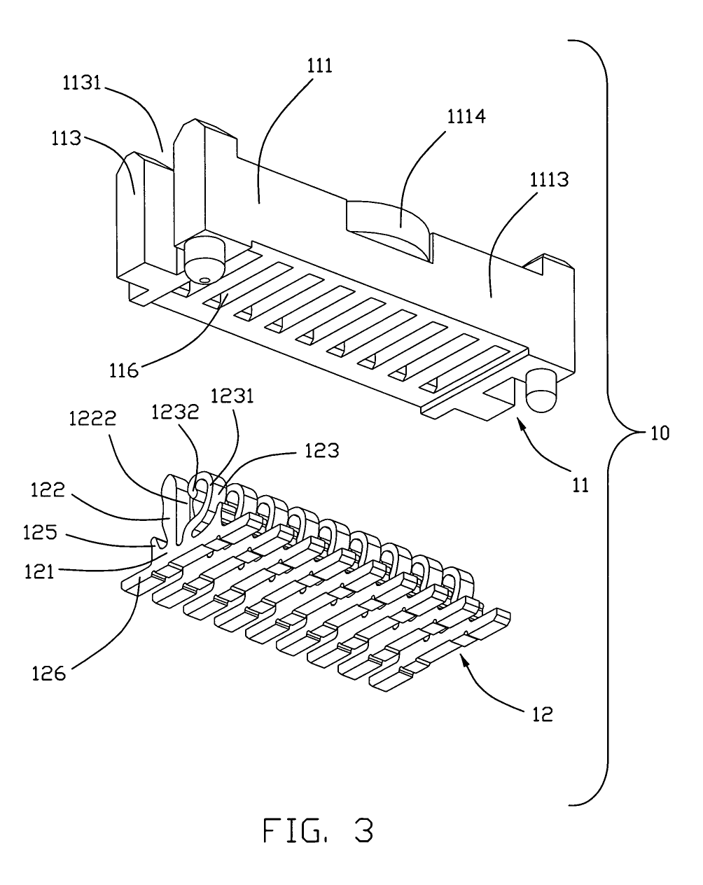

Referring to FIGS. 2 and 3, said insulating housing 11 with a longitudinal body defines an engaging portion 111, a supporting portion 112 extending laterally and horizontally from a bottom of said engaging portion 111, and two pairs of guiding posts 113 extending upwardly from two opposite longitudinal ends of said insulating housing 11. A top face of the supporting portion 112 is formed below a top surface of the engaging portion 111 so that a receiving space 117 is provide between the two opposite guiding posts 113 and an inner surface 1112 which is connecting the engaging portion 111 and the supporting portion 112. Said top face of the engaging portion 111 is designed as a mating surface 1111, the top face of the supporting portion 112 designed as a supporting surface 1121. Said mating face 1111 has an arc-shaped flat portion 1114 protruding horizontally on an outer surface 1113 of the engaging portion 111. Said flat portion 1114 is formed in a middle area of said mating face 1111 on a lateral edge in order to make it easy to be adsorbed by an absorber during the transportation. A plurality of passageways 116 are arranged along the longitudinal direction of the insulating housing 11 and each comprises a vertical passageway 114 and a horizontal passageway 115. Said vertical passageway 114 downwardly runs through the mating surface 1111 of the engaging portion 111 and opens to the receiving space 117. The horizontal passageway 115 runs through the supporting surface 1121 and a bottom of said supporting portion 112. Said vertical passageway 114 and horizontal passageway 115 are formed one to one and communicates with to each other correspondingly, which forms the passageway 116 for receiving the contact 12. Said guiding posts 113 are formed higher than said engaging portion 111 and supporting portion 112 and define a receiving slot 1131 therebetween.

As referring to FIG. 2, the contacts 12 are assembled upwardly into said passageways 116 of the insulating housing 11. Each contact 12 has a horizontal base portion 121, a pair of soldering legs 126 extending horizontally from two ends of said base portion 121, a male mating arm 122 extending upwardly from said base portion 121, and a spring female mating arm 123 extending from said base portion 121 besides said male mating arm 122. Said male mating arm 122 is substantial straight and substantial perpendicular to said horizontal base portion 121. As best shown in FIG. 4, the base portion 121 is retained in the passageways 116 adjacent to the bottom of the insulating housing 11. A pair of retaining blocks 125 are formed on two outsides of said male mating arm 122 and female mating arm 123 respectively and extends upwardly into said passageway 116 for leaning against an inner surface of said passageway 116 and fitly retaining said contact 12. Said soldering legs 126 extend out of said insulating housing 11 horizontally from a bottom of said engaging portion 111 and said supporting portion 112 for connecting with a PCB.

In FIG. 4, each male mating arm 122 upwardly extends from said horizontal passageway 115 and projects beyond the supporting surface 1121 of the supporting portion 112. Two sides of said male mating arm 122 define a first mating face 1221 and a second mating face 1222 respectively. Said first mating face 1221 forms a concave 1223 in a middle area thereof. The female mating arm 123 is received into said vertical passageway 114 and has a spring leg 1231 extending upwardly and apart from said male mating arm 122 in order to improve the flexibility thereof. Said spring leg 1231 has a free tip end extending curlily toward said male mating arm 122 which forms an arc-shaped mating portion 1232 and a gap 124 between said male mating arm 122 and the mating portion 1232.

As referring to FIG. 4, the electrical connector 10 is adapter for mating with an identical counter connector 20 having a completely same structure with the electrical connector 10. For facility understanding, the identical counter connector 20 is labeled with the reference numerals with a first arabic numeral 2 to distinguish the electrical connector 10 and the counter connector 20, but only for distinguish.

As shown in FIG. 5, when the counter connector 20 mates with said electrical connector 10, said male mating arm 222 of said counter connector 20 is received into said gap 124 of said electrical connector 10 and contacts with said female mating arm 123 of said electrical connector 10 by the engagement of said concave 2223 and said arc-shaped mating portion 1232, while the male mating arm 122 of the electrical connector 10 is received into the gap 224 of the counter connector 20 and contacts with the female mating arm 223 of the counter connector 20 by the engagement of said concave 1223 and said arc-shaped mating portion 2232. Said engaging portion 111 of the electrical connector 10 engages with the supporting portion 212 of the counter connector 20 while said supporting portion 112 of the electrical connector 10 engages with the engaging portion 211 of the counter connector 20. Said electrical connector 10 and counter connector 20 are formed same to each other so that they can share a same mold during the manufacturing process, which reduces the cost easily. Said female mating arms 123, 223 of the electrical connector 10 and the counter connector 20 are formed flexible and have a deformation during the mating process, which reduces the mating force and makes the mating process between said electrical connector 10 and counter connector 20 easily. Moreover, either the electrical connector 10 or the counter connector 20 has a hermaphroditic type contact 12, 22 with said male mating arm 122, 222 and female mating arm 123, 223 thereon, which not only reduces the manufacturing cost, but also reduces the size of said electrical connector 10 and counter connector 20. It can be noted that alternately the female mating arm 123, 223 can be sandwiched between the male mating arms 122, 222.

However, while the preferred embodiment of the invention have been shown and described, it will apparent to those skilled in the art that changes and modifications may be made therein without departing from the spirit of the invention, the scope of which is defined by the appended claims.

What is claimed is:

1. An electrical connector comprising:
an insulating housing of one piece comprising an engaging portion, a supporting portion and a plurality of passageways along a longitudinal direction of the insulating housing, said engaging portion and said supporting portion respectively defining a mating surface and a supporting surface;
a plurality of contacts retained in the passageways, each contact comprising a base portion retained in the passageway, a male mating arm and a female mating arm respectively extending upwardly from said base portion; wherein
said female mating arm has a spring leg extending apart from said male mating arm, said spring leg has a mating portion at a free tip end thereof curlily extending toward said male mating arm, said male mating arm projects upwards beyond the supporting surface of the supporting portion.

2. The electrical connector as claimed in claim 1, wherein said male mating arm and female mating arm of the contact define a gap therebetween.

3. The electrical connector as claimed in claim 1, wherein said male mating arm and female mating arm of the electrical connector respectively mate with a female mating arm and a male mating arm of an identical counter connector.

4. The electrical connector as claimed in claim 2, wherein said mating portion extends lower than a top end of the male mating arm.

5. The electrical connector as claimed in claim 2, wherein said male mating arm has a first mating face with a concave formed thereon.

6. The electrical connector as claimed in claim 5, wherein said insulating housing has at least one pair of mating posts formed upwardly on two longitudinal ends of said engaging portion and supporting portion.

7. The electrical connector as claimed in claim 6, wherein said engaging portion has a plurality of vertical passageways for receiving said male mating arms, while the supporting portion has a plurality of horizontal passageways for receiving said male mating arms respectively.

8. The electrical connector as claimed in claim 1, wherein said male mating arm is formed on one side of said female mating arm and extends higher than said female mating arm upwardly.

9. The electrical connector as claimed in claim 8, wherein said female mating arm has a movement deviating from said male mating arm horizontally during the mating process with an identical counter connector.

10. The electrical connector as claimed in claim 9, wherein said male mating arms are located between said female mating arms and connecting with each other after the electrical connector mates with the identical counter connector.

11. The electrical connector as claimed in claim 10, wherein said base portion of each contact defines a pair of retaining blocks on two outsides of said male mating arm and female mating arm respectively for leaning against an inner surface of said passageway.

12. The electrical connector as claimed in claim 11, wherein said insulating housing has at least one pair of mating posts extending upwardly from two sides of the plug, each pair of mating posts define a receiving slot therebetween for engaging with the mating post of the identical counter connector.

13. The electrical connector as claimed in claim 12, wherein said mating surface of the engaging portion is formed above said female mating arm and has a horizontal flat portion extending outwardly.

14. A connector assembly comprising:
a first connector including:
a first insulative housing;
a plurality of first contacts disposed in the first housing, each of said first contacts defining a first stiff contacting arm and a first resilient contacting arm; and
a second connector including:
a second insulative housing;
a plurality of second contacts disposed in the second housing, each of said second contacts defining a second stiff contacting arm and a second resilient contacting arm; wherein
during mated, the first stiff contacting arm is intimately sandwiched between said second stiff contacting arm and said second resilient contacting arm, and the second stiff contacting arm is intimately sandwiched between said first stiff contacting arm and said first resilient contacting arm.

15. The connector assembly as claimed in claim 14, wherein the first connector and the second connector are similar to each other.

16. The connector assembly as claimed in claim 15, wherein said first housing and said second housing each define a L-shaped cross-section for complementary mating with each other.

17. The connector assembly as claimed in claim 15, wherein before mating, said first stiff contacting arm and said second stiff contacting arm are exposed to an exterior while said first resilient contacting arm and said second resilient contacting arm are hidden behind the corresponding first housing and the second housing.

18. A connector assembly comprising:
a connector and a complementary connector each defining an insulative housing with a plurality of contacts therein, each of said contacts including a stiff contacting arm and a resilient contacting arm; wherein
during mating, each of the contacts of the connector and each corresponding one of the contacts of the complementary connector forms a pair including a pair of stiff contacting arms and a pair of resilient contacting arms under a condition that in each pair, the pair of stiff contacting arms either are commonly sandwiched between said pair of resilient contacting arms or commonly sandwich said pair of resilient contacting arms therebetween.

19. The connector assembly as claimed in claim 18, wherein said connector and said complementary connector are similar to each other.

20. The connector assembly as claimed in claim 19, wherein the housing of each of said connector and said complementary connector defines a L-shaped cross-section for complementary mating with each other.
